(19) United States
(12) Patent Application Publication
(10) Pub. No.: US 2006/0019016 A1
(43) Pub. Date: Jan. 26, 2006

(54) Composition for preparing a food product that is at least partially gelled

(75) Inventor: Philippe Torcatis, Reze (FR)

Correspondence Address: DENNISON, SCHULTZ, DOUGHERTY & MACDONALD, 1727 KING STREET, SUITE 105, ALEXANDRIA, VA, 22314, US

(73) Assignee: Palga International

(21) Appl. No.: 11/024,730

(22) Filed: Dec. 30, 2004

Related U.S. Application Data
(60) Provisional application No. 60/590,934, filed on Jul. 26, 2004.

(30) Foreign Application Priority Data
Jul. 23, 2004 (FR) FR 04/08158

(51) Int. Cl. A23L 1/05

(52) U.S. Cl. 426/573

(57) ABSTRACT

The present invention provides a powdered composition for preparing a heat-stable food product that is at least partially gelled, wherein the composition essentially comprises the following ingredients as a percentage by weight with respect to a total of 100% of said ingredients representing 100%: 1) 5% to 50% of sodium alginate; 2) 0 to 50% of a slow-dissolving calcium salt that can react with the sodium alginate to form a calcium alginate gel; 3) 0 to 25% of an agent for retarding the reaction between the sodium alginate and said calcium salt; 4) 20% to 95% of a dispersing agent optionally also constituting a water retention agent, selected from sugars, polysaccharides of vegetable origin selected from maltodextrins, native or modified starches and native or modified celluloses, and vegetable proteins. The present invention also provides a method of preparing a food product that is at least partially gelled, wherein the method comprises bringing a composition of the invention into contact, preferably by mixing, with a raw food material.

The present invention relates to a powdered composition for preparing a heat-stable food product that is at least partially gelled.

The present invention also relates to a method of preparing a heat-stable food product that is at least partially gelled, and to the food product obtained.

More particularly, the present invention provides food products reconstituted from raw food material, which may be supplemented with water, which are brought into contact for absorption and, if appropriate, homogenization, then are allowed to stand to allow gelling to take place, as is explained below.

### BACKGROUND OF THE INVENTION

The technique of forming a heat-resistant gel by reacting sodium alginate with a calcium salt is known; the chemical reaction creates heat-resistant calcium alginate.

In general, the operating procedure consists in pre-mixing sodium alginate with a raw food material which may optionally be supplemented with water and a retarding agent, then in a second stage, adding the calcium salt (which can optionally be dispersed in a little water) before allowing gelling to take place to obtain a food product.

The food products obtained are not satisfactory for a number of reasons.

Firstly, the finished product obtained often has a gelatinous in-mouth texture which is unpleasant and which deviates from the original in-mouth texture of the raw food material concerned.

Further, the food product obtained does not have good water retention properties; in particular, it produces too much aqueous exudate, resulting in a very poor yield during storage, and in particular during cooking.

Other techniques for restructuring food products based on a composition of animal collagen fibers or on blood plasma or on enzymes of bacterial origin (transglutaminases) are also known, but in a large number of countries, including France, such compositions of animal origin are banned for preparing uncooked food products.

### OBJECTS AND SUMMARY OF THE INVENTION

The aim of the present invention is to provide a food composition that can be used to prepare heat-stable reconstituted food products that are at least partially gelled by bringing said composition into contact, in particular by mixing, with a base raw food material and water, if appropriate, which allows:

the ingredients for said composition to be mixed all at once, i.e. the gelling agent for the alginate is not added separately to retard gelling, and

a dispersible powder to be produced which enables said composition to be introduced simply by dusting said base raw food material or by incorporating it in the form of a solution or a suspension pre-mixed with water, said composition then being easy to homogenize as a mixture with said raw food material.

A further aim of the present invention is to provide said food composition which enables a finished gelled food product to be prepared which has water retention properties to respectively facilitate gelling of said food product, increase the yield of the food product on storage, defrosting, and cooking, and improve the in-mouth texture of the finished food product, more particularly to enhance tenderness while retaining an in-mouth texture that is very close to the texture of the base raw food material.

The invention also aims to provide a food product with enhanced integrity, in particular on cooking, if appropriate.

The present invention also aims to provide a food product in the form of separate pieces, but which are processed to endow them with properties of integrity, water retention and other advantageous properties of the invention, in particular textural properties, by reinforcing their superficial layer, or even internal texture, and by keeping them separate without causing the pieces to cohere.

To this end, the present invention provides a powdered composition for preparing a heat-stable food product that is at least partially gelled, wherein the composition essentially comprises the following ingredients as a percentage by weight with respect to a total of 100% of said ingredients:

1) 5% to 50% of sodium alginate, preferably 8% to 25%, more preferably 8% to 15%;

2) 0 to 50% of a slow-dissolving calcium salt that can react with the sodium alginate to form a calcium alginate gel, preferably calcium sulfate or calcium hydrogen phosphate;

3) 0 to 25% of an agent for retarding the reaction between the sodium alginate and said calcium salt, preferably tetrasodium pyrophosphate or sodium citrate, more preferably trisodium citrate;

4) 20% to 95% of a dispersing agent optionally also constituting a water retention agent, selected from sugars, polysaccharides of vegetable origin selected from maltodextrins, native or modified starches and native or modified celluloses, and vegetable proteins.

Some of the agents in the list mentioned above are exclusively agents with a dispersing function, such as sugars or polysaccharides of vegetable origin of the maltodextrin type; others are essentially water retention agents but also have a dispersing function as regards the alginate, namely native or modified starches, native or modified celluloses and vegetable proteins.

In a preferred implementation, a powdered composition essentially comprises the following ingredients, as a percentage by weight with respect to a total of 100% of said ingredients:

1) 5% to 50% of sodium alginate, preferably 8% to 25%, more preferably 8% to 15%;

2) 0 to 50% of a slow-dissolving calcium salt that can react with the sodium alginate to form a calcium alginate gel, preferably calcium sulfate or calcium hydrogen phosphate;

3) 0 to 25% of an agent for retarding the reaction between the sodium alginate and said calcium salt, preferably tetrasodium pyrophosphate or sodium citrate, more preferably trisodium citrate;

4) 0.1% to 90% of water retaining texturing agent(s) selected from:

starches of vegetable origin, preferably at least pre-gelled; and

vegetable proteins; and

native or modified celluloses; and

hydrocolloid polymers such as pectins or gums, of bacterial or vegetable origin; said proportion by weight of texturing agent(s) being constituted by:

0 to 10% of said hydrocolloid polymer(s), with at least 1% of said hydrocolloid polymer(s), or at least 0.1% of said hydrocolloid polymer(s), of bacterial origin, in the presence of less than 15% of the ensemble of said starches, celluloses and vegetable proteins; and

0 to 90% of said starches and vegetable proteins, with at least 15% of said starches, celluloses and vegetable proteins in the presence of less than 1% of said hydrocolloid polymers and less than 0.1% of said hydrocolloid polymers of bacterial origin; and

5) 0 to 85%, preferably 40% to 70%, of dispersing agent(s) selected from sugars and polysaccharides of vegetable origin, more preferably selected from maltodextrins and native starches, and food quality mineral dispersing fillers such as colloidal silica;

the total of said water-retaining texturing agent(s) and said dispersing agents(s) representing 20% to 95%.

The term “dispersing agent” as used here means an agent which disperses the composition properly and in particular prevents or limits the formation of curd-like inhomogenous aggregates or structures caused by the sodium alginate reacting with the water added or contained in the product to be treated during use of the composition. It allows the composition to be dredged directly and thus avoids preparing the gel (composition+water) separately, which necessitates more complex organization and additional equipment for mixing and shearing and/or cutting, in particular a mixer or chopping machine.

The presence of a dispersing agent is not essential when processing certain liquid, paste, or finely divided products.

In fact, each of the agents other than the sodium alginate will also play a relatively dispersing role with respect to the sodium alginate.

The term “water retention agent” means an agent which has a physical structure and physico-chemical properties which can retain water and in particular prevent water from flowing or evaporating under storage, defrosting or cooking conditions.

The term “texturing agent” means an agent which has the property of modifying the texture of the finished raw or cooked product, for example by increasing its elasticity, sliceability, tenderness, or firmness.

The “at least partially pre-gelled starches” are products that are known in the art and that are commercially available. They are starches, which may optionally have been cooked, generally in the presence of water, causing at least partial gelatinization or gelling, i.e. gelling is not necessarily complete, and which have then been dried, and preferably ground. In known manner, said starches may be chemically modified with respect to the native molecule. In accordance with the present invention, the hot water retention properties of a pre-gelled starch can be advantageous, as can the texture of the food products obtained after processing and gelling, as will be described below.

Examples of starches of vegetable origin that can be cited are corn, potato and cassava starches.

Examples of vegetable proteins that can be cited are soya, pea, corn and cereal proteins. The vegetable proteins can be in the form of protein isolates or concentrates.

Examples of said hydrocolloid polymers that can be cited are pectins and gums of vegetable origin, namely guar gum, gum Arabic, konjac, carob, gelan, tara, carrageenan, and agar gum, and gums of bacterial origin such as xanthan gum.

Said hydrocolloid polymers are also thickening agents.

Examples of modified celluloses that can be cited are carboxymethyl cellulose, methyl cellulose and hydroxypropyl methyl cellulose, also microcrystalline cellulose.

Vegetable fibers, which are constituted, inter alia, by celluloses and/or pectins, are thus included in the definition of water retention agents. Similarly, crumb coatings (chapelure), which are mixtures of proteins and wheat flour starches, or other cereals or legumes, are also included in the definition of the water retention agents of the invention.

Particular examples of sugar type dispersing agents that can be cited are dextroses, glucose, saccharoses and fructose.

Preferably, the composition of the invention does not include any ingredients of animal origin.

This composition is intended to be mixed with a base food product hereinafter termed the “raw food material”, then it can if necessary be hydrated and, in all cases, gelled to create at least partially gelled food products.

The term “at least partially gelled food products” means that at least part of the food product is in the gelled form but gelling is complete.

The composition of the invention can process the raw food material to endow the final food product obtained with specific advantageous properties and bring about re-structuring by binding or separating pieces of processed food material, as will be described below.

The alginate acts as a binding agent for the different ingredients of the composition and also acts as a water retention agent. However, its water retention is insufficient, in particular on storage, defrosting, and when hot. Said water-retaining texturing agent of the invention “recovers” water lost by the alginate gel and the processed product during storage and/or defrosting and/or cooking. In addition to good integrity on cooking, the water-retaining texturing agent also endows the food product obtained in accordance with the invention with a texture that can be modified in its nature and proportions, after processing with said composition.

The binding properties of the alginate makes it tend to form inhomogenous curd-like structures when using the composition, and a composition comprising it, and it is thus not readily dispersible as-is by simple dredging. Said “dispersing” agent contributes to making the composition dispersible in a homogeneous manner, such as by dredging, without having recourse to mixing means comprising equipment of the mixing and shearing and/or cutting equipment type such as a mixer or chopping machine, including a knife, in particular of the cutter type, or a blade chopper of the Moulinette or reciprocated type, to disperse the composition and break inhomogenous structures.

In this composition, the amount of sodium alginate can be relatively much smaller than in the usual compositions based on sodium alginate or in preparations involving separate incorporation of the different components. This low sodium alginate content, compensated by the use of a significant proportion of an additional texturing agent and, if appropriate, a gel retarding agent, can solve the various problems at the root of the invention, namely:

simultaneously mixing the different ingredients of the composition, in particular sodium alginate and, if appropriate, a calcium salt and/or retarding agent, with better dispersibility and, if appropriate, deferred gelling, and

optimizing the texture of the reconstituted food product after treatment with said composition and gelling, as well as improving its water retention properties.

Retarded gelling allows the mixing and molding operations to be carried out before gelling commences (or is sufficiently advanced to deleteriously affect the integrity of the finished product), which means that the gel formed or being formed does not break.

The proportions of the different ingredients of the composition, in particular said texturing agents, depend:

on the nature and size of any pieces of raw food material with which they are intended to be mixed to form the final food product; and

on the mixing equipment and type employed; and

on the properties of said composition and the finished food product to be prepared, in particular the desired consistency and texture.

Compound 2 (calcium salt) is absent or present in a small amount only when the raw food material which is subsequently mixed with said composition itself includes calcium salts which can be released progressively to react with the sodium alginate of the composition and induce retarded gelling. This is particularly the case with a raw food material constituted by cheese.

Compound 3 (retarding agent) is absent or present in a small amount only when the base raw food material intended for subsequent mixing with said composition itself includes an element which can retard the gelling reaction, or when a more rapid or instantaneous reaction is to be obtained.

The proportions and nature of the calcium salt and the retarding agent used will also depend on the pH of the starting material and on the presence or absence of preservatives and cooking salt. For relatively more acidic pHs, such as beef compared with poultry, a composition with a relatively greater retarding agent content will be used to avoid it setting too rapidly. The sodium or potassium salts which are found in cooking salt and certain preservatives have a retarding effect (or destructive effect in high quantities) on gelling, and they reduce the integrity of the final product after treatment. In their presence, it is preferable to increase the amount of calcium salt. This is also the case if a curing treatment, for example churning, dredging, or immersing, is to be carried out using brine or a liquid or dry marinade.

Calcium sulfate is thus used for food products based on a neutral or alkaline starting materials and calcium phosphate such as calcium hydrogen phosphate (CaHPO₄) is used for starting materials with a rather acidic pH (pH<3.5), such as certain of said starting materials based on fruit, vegetables, and certain smoked fish or meat.

The composition of the present invention may act as a kind of adhesive, allowing a food product to be reconstituted from the base starting material resulting from the composition gelling after mixing. However, as can be seen below, under certain complementary processing conditions, the composition of the invention can, in contrast, allow pieces of treated food material to be separated by preventing them from cohering.

As explained below, the reconstituted food products obtained in accordance with the present invention can be produced from raw food material in the form of juice, puree, dehydrated powdered material (powder or flake), or pieces of various sizes, which generally involves adding water during the preparation method and which can optionally be seasoned, flavored, or colored, then shaped. These products produce little or no exudate. Their yield on storage or cooking is close to that of the raw food materials used before rehydration, without adding salt. Finally, the integrity on cooking the finished food products is satisfactory.

Even if the raw food material does not have water retention properties, once the water is absorbed, the composition of the invention induces water retention when cold and during storage, and when hot during cooking. The term “yield” as used here refers to the quantity of water added or present in the food product which is to be preserved.

The texturing properties of the composition of the invention result in an increase in the tenderness of certain relatively hard raw food materials such as some meats, in particular turkey shoulder, or some fish such as tuna. More particularly, they can preserve or improve the original in-mouth texture of tender products such as foie gras or certain cooked fruits that are difficult to preserve, such as cooked banana. Finally, for cheese-making applications, they allow stringy and fondant textures to be produced which are stable on cooking and which retain a cheese-like in-mouth texture.

In one variation of the invention, which is most generally suitable, the composition of the invention can, if necessary, comprise 5% to 30% of said calcium salt which can react with sodium alginate.

Similarly, more generally, the composition of the invention can if necessary be used with 0.5% to 15%, preferably 2% to 10%, of said agent that retards reaction between the sodium alginate and said calcium salt.

In a preferred implementation, said water-retaining texturing agent is selected from said pre-gelled starches and said vegetable proteins.

Said water-retaining texturing agents also provide the composition with dispersibility properties. In general, said pre-gelled starches are used to give the final resulting food product a tender texture, while vegetable proteins are used to produce a firmer texture.

In certain particular cases, the composition will comprise at least 50% of water-retaining texturing agent constituted by a vegetable protein.

Advantageously, said dispersing agent is selected from dextrose type sugars. This ingredient is advantageous since it is highly dispersing and only slightly sweetening and will in any case sweeten the preparation if an excess is used.

In a preferred implementation, said pre-gelled starch has a grain size of 0.020 mm (millimeters) to 1 mm, preferably 0.025 mm to 0.4 mm.

Preferably again, said composition of the invention comprises cassava starch as said water-retention agent, optionally partially pre-gelled.

Partially pre-gelled cassava starch has the advantage of being in the form of relatively large grains which can simulate the in-mouth texture of a fat, in particular in meat and fish, and thus can endow those products with tenderness. For this reason, the in-mouth tenderness provided by this type of cassava starch, because of its grain size and its texture when hot, is remarkable. Further again, after gelling, it also makes the gel adhesive and stringy, which is highly advantageous when processing cheese. Finally, surprisingly, and in a manner that has not yet been fully elucidated, it can almost completely restore the authentic in-mouth texture of cooked vegetable and fruit as regards texture.

Further, since it absorbs about 5 times its own volume of water when cold, it can considerably improve the water retention of the finished product during the different phases of storage and any defrosting. Furthermore, the formation of a viscous starch gel during cooking can improve water retention and tenderness.

In a particular implementation, the composition of the present invention comprises:

8% to 25% of said sodium alginate;

15% to 50% of water-retaining texture agent selected from said pre-gelled starch and said vegetable protein, preferably pre-gelled cassava starch, and/or a vegetable protein isolate or concentrate;

30% to 70% of said dispersing agent, preferably of the sugar or maltodextrin type, more preferably of the dextrose type;

5% to 30% of said calcium salt; and

0.5% to 15% of said retarding agent.

This manner of producing the composition is relatively flexible and can be applied to a wide range of raw food materials as long as they include very little or no soluble calcium which can be used by the alginate.

This composition has the advantage of being relatively flexible in application, both in terms of the nature and the size of the pieces of raw food material, so long as said raw food material contains very little or no calcium. Thus, it is not suitable or not very suitable for cheeses, but is preferred for “moist” material such as meat, fish, vegetable and fats.

In a further implementation, the composition of the invention comprises:

0 to 10% of said dispersing texturing agent, preferably 0%; and

at least 20%, preferably at least 40%, of said water-retaining agent selected from said pre-gelled starches and said vegetable proteins, preferably said pre-gelled starches.

This composition is of particular advantage for raw food material to be mixed for which the composition may have reduced dispersion properties, it being understood that a certain dispersion is nevertheless supplied in part by the selected water retention agents.

In a further implementation, the composition of the present invention comprises:

8% to 25% of said sodium alginate;

0% of said calcium salt that can react with the alginate;

0.5% to 10% of said retarding agent;

0 to 10% of said dispersing agent, preferably 0%;

60% to 90% of said water retention agent selected from said pre-gelled starches, preferably a pre-gelled cassava starch, more preferably with a grain size of 0.020 mm to 1 mm, preferably 0.025 mm to 0.4 mm; and

0 to 20% of an emulsifying salt such as a polyphosphate.

The role of said emulsifying salts is to facilitate melting of the cheese without separating. Such products are known in the art.

This composition, which produces a gel which produces longer strings when hot, is particularly suitable for preparing cheese-based food products.

When said composition is intended to be mixed with a raw food material that is slightly acidic or of medium acidity, neutral or alkaline, said calcium salt is advantageously calcium sulfate and said retarding agent is tetrasodium pyrophosphate (Na₄P₂O₇).

In contrast, when said starting material is a strong acid with a pH of <3.5, then advantageously, said calcium salt is calcium phosphate, preferably calcium hydrogen phosphate and said retarding agent is sodium citrate, preferably trisodium citrate.

To produce a pH of <3.5, then advantageously again, the composition of the present invention comprises additional ingredients which can reduce the pH, preferably citric acid, more preferably in an amount which is less than 1.5%.

In one implementation, the composition of the invention is supplemented by a fat or oil of human or animal food quality. Said fat or oil also has an additional dispersing effect on the different ingredients of the composition.

The present invention also provides a method of preparing a food product which is at least partially gelled, wherein the method comprises bringing a composition in accordance with the invention into contact with a raw food material, preferably by mixing.

The raw food material can be classified into different categories using terminology that is known to the skilled person:

1. “Moist material”, i.e. containing free water, preferably with Wa>0.95 (Wa=water activity).

The following can be distinguished:

1.1. Raw, fresh or cooked natural materials such as fruit, vegetables, meat, fish.

The term “meat” as used here means muscle or offal or products derived from muscle or offal from cattle, sheep, game, pigs, Caprinae, poultry, ostrich and more generally any earthbound animal or bird including cetaceans, and the term “fish” as used here means muscle or offal or products derived from the muscle or offal of any edible aquatic animal, including crustaceans and mollusks.

Skin, ground fish and animal bones are also included, in particular those from separators, machines for mechanically recovering meat, or pulp.

1.2. Transformed natural products such as cooked dishes, dairy products, in particular desserts and cheeses, and butchery products such as pates, ham, smoked meats or sausages.

These raw, fresh or cooked natural materials or transformed natural materials can be in the solid or viscous form.

Solid or pasty materials can be in pieces of various sizes, such as:

fine materials, with pieces the largest dimension of which is less than 3 mm;

small pieces with larger dimensions of 3 mm to 3 cm (centimeters);

large pieces, generally of larger dimensions of 3 cm to 10 cm, or more in the case of pieces of muscle or whole muscle.

Said solid or viscous pieces can be whole products, in particular in the case of small fruits or small vegetables or small aquatic products such as crustaceans or mollusks.

Said solid or paste pieces can also be grated, chopped or cut products for the small and large pieces, and ground products for fine products, in particular those in the form or a coulis or puree.

Said moist materials can also be in the liquid form. More particularly, they can be in the form of an aqueous solution such as juice, in particular fruit or vegetable juice, dairy products or sauces.

2. “Semi-moist materials”, i.e. containing bound water, preferably with Wa<0.8. They are part-dried or part-rehydrated products which may contain moistening agents such as sugar, glycerol or monopropylene glycol.

In general, they are transformed products such as jelly (jam), fruit pastes, or soft granules for animal feed, in particular for pet food. Such products are generally in the form of a puree, paste, or solid product with granules with a viscous or gelatinous consistency.

The expressions “moist materials” and “semi-moist materials” are categories of food materials which are known in the art.

3. Fats such as fats or oils, which can be in the solid, viscous, or liquid form.

4. Dehydrated materials, which may be freeze dried, which are generally in the powder form or as whole pieces or ground, flaked, granulated, strips, cut pieces, or flakes on a support.

Said dehydrated products may be of natural origin, such as dried meat or fish, vegetables, or dried fruit.

Most generally, a method of the invention comprises mixing a composition in accordance with the present invention with said raw food material and water.

More particularly, in a method of the invention, all of the ingredients of said composition are mixed together simultaneously, since the composition is dispersed in the powder state, with said starting material and any water to be added until said composition is homogeneously distributed around said starting material, and any water in said starting material has been absorbed before the onset of gelling, then it is left to stand to allow gelling.

Said composition, said starting materials and any water can be mixed then formed, in particular in a mold or former, or by extrusion if the texture before gelling is firm enough.

The food product obtained after said mixing and, if appropriate, prior to gelling, can be packaged into a rigid or flexible packaging, in particular into a flexible envelope of material of natural or synthetic origin, in particular pushed into a sausage casing.

Shaping and/or the packaging, if it acts as a mold, must be carried out before the onset of gelling.

In a particular implementation of the method of the invention, mixing is carried out using the following components as a percentage by weight to give a total of 100%:

1% to 15% by weight of said composition; and

the remainder, i.e. 85% to 99% by weight, is constituted by said raw food material, supplemented with water if appropriate.

More particularly still, mixing is carried out comprising 2% to 10% by weight of said composition.

The proportions of the different components of the composition, and the relative proportions of the different components of the mixture, namely said starting material, water and said composition, depend on the nature, viscosity and quality of said raw food material, the desired gelling time and above all its characteristics, in particular as regards the physical structure and the properties of the desired final product.

In a first variation, said raw food material is constituted by a “moist” food material containing free water as defined above, or rehydrated, and the mixture comprises 0 to 50%, preferably 5% to 30%, by weight of added water.

In a second variation, said raw food material is constituted by fat, dehydrated or “semi-moist” food material containing bound water as defined above, and the mixture comprises 10% to 95% of added water.

As mentioned above, the dehydrated material may be in the form of a powder or whole or ground pieces, such as flakes, granules, strips, or pieces, and the semi-moist material is constituted by a transformed product containing bound water, in the form of a puree or paste or solid product with a viscous consistency such as a fruit paste, preserve, etc.

Said composition, said raw food material, and said optional water can be mixed simultaneously.

Especially when a lot of water has to be added, i.e. more than 20%, said mixing may be carried out in several steps comprising:

pre-mixing said raw food material with all or part of the water until said raw food material is absorbed;

dredging the composition, mixing it with the pre-mix to obtain a homogeneous mixture; and

mixing said composition and any remaining water with said pre-mix until the water in said raw food material is absorbed; and

leaving it to stand until gelling of the finished product obtained is complete;

gelling is complete or sufficient in a period of 1 to 12 hours.

Said composition and the water to be added can be pre-mixed, then:

the pre-mixed gel is added to said starting material until absorption; and

it is left to stand until gelling of the finished product obtained is complete.

Gelling is complete or sufficient in a period of 1 to 12 hours.

To reinforce the gel strength and the integrity of the food product obtained, and more particularly in the case in which the raw food materials include cooking salt and/or are used with preservatives which weaken the integrity of the products, a solution of fast-dissolving calcium salts such as calcium lactate or calcium chloride is used, preferably in 0.5% to 10% solution, which is introduced into the mixture of the various components, preferably by injection or kneading at the end of mixing, or in which it is immersed, or the resulting product is coated with a mixture of said components before, during or after gelling.

The term “coating” means encapsulating with a brush or spraying or any other means for applying the solution to the product surface.

This implementation involves treatment with a solution of fast-dissolving calcium salt after gelling and optionally after slicing or dicing, and is useful when gelling does not result in sufficient binding on cooking or slicing, in particular if the food product is too salty or it contains preservatives such as potassium lactate or sodium diacetate. Said fast-dissolving calcium salts can also be added to the food preparation used to coat or encapsulate, or which is for complete or partial penetration, of the marinade, juice, sauce, or pickle type, or an aromatic or decorative mixture of spices, fresh, chilled, deep-frozen, or dried herbs or crumb coatings which, because of their composition, in particular if too salty, risk weakening the bind and integrity of the product, if the marinade is intended to come into contact with the product (in the case of herbs or crumb coatings or a mixture of dried or whole spices, the calcium salt can be added dry).

The action of said calcium salts is also useful before gelling when shaping the food product necessitates a phase during which finished food products are obtained in the form of divided pieces which may stick to each other again, which in this case is to be avoided. In this case, said calcium salts are used at the end of mixing if the pieces are already in their final size or just after shaping, which may, for example, be extrusion if the food product is constituted by particles that are smaller than the desired size of the finished product. Said calcium salts harden the surface of the product which can, if necessary, finish hardening in the core depending on whether or not said composition contains a calcium salt.

The use of said calcium salts is particularly suitable in the context of manufacturing semi-moist granules or “spaghetti”, from fruit or vegetables, meat or fish, cheese, etc.

By extruding a paste constituted by the product resulting from mixing the raw food material in the form of a puree, juice or pieces of greater or lesser size, and said composition of the invention, in a calcium solution, this “paste” surface hardens instantly. If the core is to be hardened, it has to be left in the calcium solution for a longer period so that it penetrates into the raw food material by osmosis.

If the food product is in the form of pieces and has to retain all or part of the water added during storage and cooking without binding the pieces (i.e. without them cohering), said hardening calcium salts are used during the mixing phase for said pieces, or by immersing them individually in the calcium solution or encapsulating them or dredging them individually with the calcium solution during immersion by soaking or cooking if these operations take place prior to gelling.

In a first variation of the method of the invention, a food product is obtained in which the pieces of said raw food material cohere. In this case, the complementary treatment of strengthening the gel and the integrity is carried out by immersing or coating the resulting product in the mixture of said components in, or respectively with said fast-dissolving calcium solution or by introducing said fast-dissolving calcium solution into said product resulting from mixing said components, after gelling and optionally after slicing, or optionally during gelling if the product is shaped by extrusion or shaping before gelling, or said fast-dissolving calcium solution is introduced into said product resulting from mixing said components and after or during gelling.

In a further implementation, a food product is obtained in which the pieces of the raw food material remain separate. In this case, the complementary treatment with a solution of fast-dissolving calcium salt is carried out by introducing said fast-dissolving calcium salt solution into the product resulting from mixing the different components at the end of mixing or by immersing or coating the products resulting from mixing the different components in a fast-dissolving calcium salt solution, during or after gelling. This allows the surface of each particle or piece to gel rapidly to prevent them from cohering again.

Said gelled food product can be cooked, chilled, deep-frozen, dried, freeze dried and/or sterilized or pasteurized after gelling.

Said gelled food product can be sliced after gelling and, if appropriate, cooking and/or sterilization, then made into a brochette (kebab), if appropriate after cutting into pieces. Blocks with the dimensions of a brochette mold can be used directly in brochette molds, or they can be pre-sliced; or it is possible to superimpose different layers of different products in the mold before gelling; in this case, they will cohere and the multiple-layer block can be placed in a brochette mold, which will produce a brochette containing layers of different products which bind together; if the layers are to be separate, a fine layer of calcium solution (with calcium lactate or chloride as the calcium salt) can be applied between each layer, for example after a layer of meat and before a layer of vegetables.

Said gelled food product can be sliced after gelling and, if appropriate, after cooking or sterilizing.

Said gelled food product can be vacuum packed before or after gelling; if before, it will take up the shape of the packaging and will gel in that shape.

Thus, the present invention also pertains to a food product that is at least partially gelled, obtained by the preparation method of the invention, having improved water retention properties on storage and cooking over those of the raw food material which it contains before mixing.

As mentioned above, the food product can be constituted by pieces of said raw food material which cohere or by separate pieces of said raw food material. When said product is constituted by pieces of said raw food material, which are separate, then in one implementation, said pieces are covered with a fast-dissolving calcium solution which may be seasoned to act as a marinade, endowing them with a solid appearance.

More particularly, a food product of the invention is obtained from said raw food material mixed with said composition of the invention, in particular comprising no calcium, preferably incorporated in the form of a gel into a marinade, the product resulting from said mixture then being covered with said fast-dissolving calcium solution.

The food product of the invention can be constituted by pieces of said raw food material of different natures adhered together.

More particularly, the food product of the invention can be in the form of:

balls, pieces for brochettes, fillets, slices, tournedos, slabs, dice, large blocks, granules, and thin slices of meat, poultry, or fish; and

vegetable or fruit puree tarts, preferably pre-cooked, with or without pieces; and

pieces of cheese or cheese preparations, preferably emmenthal, goat, or mozzarella; and

solidified fats.

### DETAILED DESCRIPTION OF THE INVENTION

Other characteristics and advantages of the present invention become apparent from the following examples.

In the following examples, the substances used have the following characteristics:

gelled starch is partially pre-gelled cassava starch with a grain size of 0.020 mm to 1 mm, preferably 0.025 mm to 0.4 mm;

sodium alginate is an extract of the marine algae Laminaria Hyperborea, the viscosity of which in 1% solution is 100 Pa.s (pascal.second) to 600 mpa.s, with a gel strength of 60-70 g (FIRA test).

1. Example of a composition for food use in accordance with the invention.

Table I below shows some of the test compositions in the column under “formula”. Formula 2 is a comparative example of a composition which is not in accordance with the present invention as it includes neither water retention agent nor dispersing agent. Formulae 3 to 21 are preferred formulae as they include both dispersing agents and water retention agents.

TABLE I

| Formula | | | | | | | | | | | |
|---|---|---|---|---|---|---|---|---|---|---|---|
| number | 1 | 2 | 3 | 4 | 5 | 6 | 7 | 8 | 9 | 10 | 11 |
| Sodium | 11.85 | 39 | 11.85 | 13.2 | 9 | 11.85 | 11.85 | 23.5 | 24.69 | 11.75 | 12.35 |
| alginate | | | | | | | | | | | |
| Part gelled | | | 20.62 | 65.8 | 85 | 10.31 | 0 | 47 | 49.38 | 23.5 | 24.69 |
| cassava | | | | | | | | | | | |
| starch | | | | | | | | | | | |
| Guar gum | | | | | | | | | | | |
| Vegetable | | | | | | 10.31 | 20.62 | | | | |
| protein | | | | | | | | | | | |
| Dextrose | 69.62 | | 49 | | | 49 | 49 | | | 50 | 50 |
| Tetrasodium | 6.68 | 22 | 6.68 | 1.4 | | 6.68 | 6.68 | 6 | 1.23 | 3 | 0.615 |
| pyrophos- | | | | | | | | | | | |
| phate | | | | | | | | | | | |
| Trisodium | | | | | 0.1 | | | | | | |
| citrate | | | | | | | | | | | |
| Calcium | 11.85 | 39 | 11.85 | | | 11.85 | 11.85 | 23.5 | 24.69 | 11.75 | 12.35 |
| sulfate | | | | | | | | | | | |
| Calcium | | | | | 5 | | | | | | |
| hydrogen | | | | | | | | | | | |
| phosphate | | | | | | | | | | | |
| Citric acid | | | | | 0.9 | | | | | | |
| Emulsifying | | | | 19.6 | | | | | | | |
| salts | | | | | | | | | | | |
| (phosphate) | | | | | | | | | | | |

| Formula | | | | | | | | | | |
|---|---|---|---|---|---|---|---|---|---|---|
| number | 12 | 13 | 14 | 15 | 16 | 17 | 18 | 19 | 20 | 21 |
| Sodium | 11.75 | 11.75 | 11.75 | 11.68 | 11.68 | 11.68 | 10 | 50 | 11.85 | 22 |
| alginate | | | | | | | | | | |
| Part gelled | 14.75 | 7 | | 19.71 | 9.857 | | 80 | 50 | | 20 |
| assava | | | | | | | | | | |
| starch | | | | | | | | | | |
| Guar gum | | | | | | | | | 2.62 | |
| Vegetable | | 7.75 | 14.75 | | 9.857 | 19.71 | | | | |
| protein | | | | | | | | | | |
| Dextrose | 50 | 50 | 50 | 39.43 | 39.43 | 39.43 | | | 67 | |
| Tetrasodium | 6 | 6 | 6 | 5.52 | 5.52 | 5.52 | 10 | | 6.68 | 11 |
| pyrophos- | | | | | | | | | | |
| phate | | | | | | | | | | |
| Trisodium | | | | | | | | | | |
| citrate | | | | | | | | | | |
| Calcium | 17.5 | 17.5 | 17.5 | 23.66 | 23.66 | 23.66 | | | 11.85 | 47 |
| sulfate | | | | | | | | | | |
| Calcium | | | | | | | | | | |
| hydrogen | | | | | | | | | | |
| phosphate | | | | | | | | | | |
| Citric acid | | | | | | | | | | |
| Emulsifying | | | | | | | | | | |
| salts | | | | | | | | | | |
| (phosphate) | | | | | | | | | | |

The above formulae are cited purely by way of example; the percentage of each ingredient and the nature of the texturing agent, water-retention agent, dispersing agent, retarding agent, or calcium source are provided simply by way of illustration and are not limiting.

In particular, all of the formulae can be supplemented with a buffer, flavoring, sweetener, preservative, anti-oxidant, or coloring agent. If necessary, they should be adapted to constraints linked to the pH or the amount of retarding agent or free calcium in the raw food material. The mode of use of the compound could be modified.

All of the above formulae can thus be colored or seasoned or treated with preservatives of flavorings or anti-oxidants provided that the reaction is not accelerated too greatly, for example by reducing the pH, or supplying free calcium, or slowed, in particular by adding cooking salt.

2. Examples of proportions of formulae in the mixture

The percentage of formulae to be added depends on the type of raw food material, in particular whether it is moist, semi-moist, or dehydrated. It also depends on the size of the pieces of raw food material. Thus, for example, for moist starting materials such as meat and fish, Table II below shows the proportions of the different compositions for different sizes of pieces of meat and fish, it being understood that the quantities can always be increased to compensate, for example, for a low salt content or too fragile a texture of the base starting material, or reduced if, for example, the integrity is to be lower, possibly with poorer water retention or less textural modification.

TABLE II

| | Formulae 1, | | |
|---|---|---|---|
| | 3, 7, 10, | | |
| | 11, 12, 13, | | |
| Piece size | 14, 15 | Formula 2 | Formulae 8, 9 |
| Less than 3 mm | 5% to 7% | 1.5% to 2.5% | 2.5% to 3.5% |
| Chopped or cut: | 5% to 7% | 1.5% to 2.5% | 2.5% to 3.5% |
| 3 mm to 10 mm | | | |
| Chopped or cut: | 4% to 6% | 1.3% to 2% | 2% to 3% |
| 10 mm to 2 cm | | | |
| Chopped or cut: | 3% to 5% | 1% to 1.7% | 1.5% to 2.5% |
| 2 cm to 3 cm | | | |
| (small pieces) | | | |
| Chopped or cut: | 3% to 4% | 1% to 1.3% | 1.5% to 2% |
| 3 cm to 5 cm | | | |
| (coarse pieces) | | | |

3. Examples of mixing methods

Table III below shows different sequences of mixing steps with the proportion of composition being employed of between 1.5% and 7%, by dredging or optional pre-mixing with all or part of the water over many pieces of meat and offal such as pork, poultry, beef, veal, foie gras, etc, or fish which may or may not be supplemented with water, up to a quantity that the meat can absorb by mixing with or without vacuum.

Employing the Composition

For dry products in the form of a powder or small grains, the composition can be pre-mixed with the raw food material. If the grain size or shape of the product is such that the mixture is heterogeneous, either oil can be used to encapsulate each particle of the raw food material with the composition, before adding water, or the raw food material can be hydrated before proceeding using one of the following protocols.

For liquid or paste products, intimate mixing is carried out using a mixer or an apparatus which can actively mix the food material, any water and the composition. If a more gentle mixing system is to be used, it is sufficient to increase the quantity of dispersing agent or oil or to pre-disperse the composition in oil before incorporating it into the food product.

For a moist product constituted by small pieces which are to be preserved, the above procedure is employed, but using equipment that neither shears nor cuts to mix.

TABLE III
Example for products in pieces

| Method n^{o} 1 | | Method n^{o} 2 | | Method n^{o} 3 | |
|---|---|---|---|---|---|
| (with more than | | (with more than | | (with less than | |
| 10% added water) | | 10% added water) | | 5% added water) | |
| 1. | Pre-mix pieces | 1. | Pre-mix pieces | 1. | Pre-mix pieces |
| | (optional) | | (optional) | | (optional) |
| 2. | Add water, | 2. | Prepare a gel | 2. | Sprinkle |
| | keeping back about | | with formula and | | formula |
| | 5% | | water | | |
| 3. | Mix to | 3. | Immediately* | 3. | Add any water |
| | absorption | | add gel to product | | |
| | | | to be re- | | |
| | | | structured | | |
| 4. | Dredge formula | 4. | Mix to | 4. | Mix to |
| | | | absorption | | absorption |
| 5. | Add remaining | 5. | Mold | 5. | Mold |
| | water | | | | |
| 6. | Mix to | 6. | Leave to stand | 6. | Leave to stand |
| | absorption | | to gel (1 to 12 | | to gel (1 to 12 |
| | | | hours) | | hours) |
| 7. | Mold | 7. | Unmold | 7. | Umnold |
| 8. | Leave to stand | | | | |
| | to gel (1 to 12 | | | | |
| | hours) | | | | |
| 9. | Unmold | | | | |

*For safety, as it must be incorporated and the food product must be molded before the gel starts to set.

The following examples, using different proportions of the various mixed components depending on the type of formula, were tested:

3.1. Formula 1

Small pieces of meat or certain fish, 78%, water, 18%, formula 1, 4%.

This recipe was tested for pork, beef, mutton, lamb, guinea fowl, duck and various fish, namely salmon, tuna and trout.

Large pieces of pork meat, 79%, water, 18%, formula 1, 3%.

This recipe was tested for pork, beef, mutton, lamb, guinea fowl, duck and different fish, namely salmon, tuna and trout.

Whole chicken fillets, 80%, water, 18%, formula 1, 2%.

This recipe was tested for chicken fillets, pork filets mignon and trout fillets.

Mechanically separated turkey meat, 70%, water, 24%, formula 1, 6%.

This recipe was tested for mechanically separated meat, for ground chicken and pork and for ground beef.

Small pieces of pork belly, 88%, water, 8%, formula 1, 4%;

Small pieces of pork meat, 68%, water, 28%, formula 1, 4%.

This recipe was tested for pork, beef, mutton, lamb, guinea fowl, duck and various fish, namely salmon, tuna and trout.

Whole fillets, 88%, water, 8%, formula 1, 2%.

This recipe was tested for chicken fillets, pork filets mignon and trout fillets.

Formula 1 produces products which cannot easily hold the added water and which produce a texture with no tenderness, but it can be used for dredging.

3.2. Formula 2

Small pieces of pork meat, 78%, water, 18%, formula 2, 2%;

Tuna pulp, 68%, water, 28%, formula 2, 3%;

Deboned turkey leg, 45%, deboned turkey shoulder, skinless, 33%, water, 18%, formula 2, 1%.

Formula 2 is equivalent to formula 1 but has no dextrose. It is used in a smaller quantity (between 0.6% and 3%) but it is difficult to use for dredging, and so a gel has to be prepared using method n° 2 to employ it.

3.3. Formulae 3, 6 and 7

These formulae are used at between 2% and 7% for dredging or pre-mixed with some or all of the water (see Table III above) for a variety of meats such as pork, poultry, beef, etc, or fish supplemented or not supplemented with water up to a quantity that the beef can absorb by mixing, with or without vacuum. It produces finished food products which retain a large proportion of added water, enhancing the tenderness or firmness of the finished products.

When used dry or with very little water on large pieces or whole muscle, they can be dredged directly onto the pieces or those which can be encapsulated with formula.

Their capacity to produce tenderness (especially formulae 3 and 6) allows them to be used for a variety of fruit or vegetables such as banana, potato, broccoli or carrots, alone or as a mixture.

Formulae 6 and 7, which comprise vegetable proteins and less cassava starch, are used to impart greater in-mouth firmness, for example with fish products. 3.3.1. Examples of recipes with formulae 3, 6 and 7:

Small pieces of meat or fish, 68% to 96%, water, 4% to 28%, formula 3, 4% to 6%.

This recipe was applied to meat from all parts of the body of various species of poultry such as guinea fowl, turkey, duck, chicken, game or meat (beef, veal, pork, lamb, mutton, ewe, ostrich, emu, bison, etc), including some offal such as liver or heart, as well as fat in pieces, in particular pork belly, as well as pieces of tuna, salmon, trout and hake flesh.

Whole fillets, 70% to 90%, water, 8% to 28%, formula 3, 2%.

In the above examples, the chicken fillets can be replaced by tuna, salmon or trout muscle, fillets of meat from all poultry species, in particular chicken or duck, game or meat (beef, veal, lamb, mutton, ewe, ostrich, emu, bison, etc) as whole muscles if they are small or in large pieces. The percentage of formula also depends on the surface to be cohered.

Mechanically separated turkey meat, 47.5% to 94%, water, 0 to 45%, formula 3, 5% or 6%.

Hake pulp, 78% to 94%, water, 0 to 17%, formula 6, 5%.

In the above examples, the turkey meat can be replaced by tuna, salmon or trout pulp, ground or mechanically separated meat from all poultry species, game or meat (beef, veal, lamb, mutton, ewe, ostrich, emu, bison, etc), including some offal such as liver or heart, as well as chopped fat.

Ground bone from separator, 76%, ground liver and heart, 19%, formula 3, 5%;

Ground bone from separator, 66%, ground liver and heart, 29%, formula 3, 5%.

Pureed foie gras, 89.99%, water, 12.5%, formula 3, 4.17%;

Pureed foie gras, 78.48%, water, 15.58%, ground pepper 0.12%, formula 3, 5.55%;

(15% mechanically separated turkey meat and 85% pieces of turkey shoulder), 77.5%, water, 18%, formula 3, 4.5%;

Ground beef meat, 25%, ground pork, 25%, water 20%, chopped cooked beetroot, 25%, mixture 3, 5%.

The various starting materials, meat, fish or vegetables, can be mixed together during preparation.

The various starting materials can also be simply brought into contact on molding after preparation.

It is also possible to prepare a marbre of fish (see photo), mixed turkey roasts, brochettes with multiple layers of different meats, brochettes with poultry stuffed with foie gras, duck fillets stuffed with foie gras and tournedos.

Liquid melted duck fat, 47%, water, 47%, formula 3, 6%.

Preferably, the formula is pre-mixed with water before mixing it with the fat. This recipe produces a product which can be sliced and does not melt on cooking. For greater firmness, the amount of fat can be reduced and/or the amount of formula 3 can be increased or replaced with formulae 6, 7, 12, 13, 14, 15, 16 or 17.

Further, the duck fat can be replaced by oil, other molten fats or water to obtain a very low-fat product as a fat substitute.

If more solid fats are used such as pork or beef fat, a recipe for meat pieces can be employed with or without melting the fats.

3.3.2. Examples of recipes for fruit and vegetables with formula 3

Fruit juice (pH>5), 90%, formula 3, 10%.

To obtain a texture that is closer to the initial fruit, pre-gelled cassava starch can be added, optionally pre-mixed with formula 3 to obtain a new mixture.

Fresh banana puree, 44.25%, fresh banana pieces, 38.94%, formula 3, 3.54%, icing sugar, 5.31%, partially gelled cassava starch, 7.96%.

Pears in syrup with syrup, 45.45%, fresh diced peeled pears, 45.45%, formula 3, 3.64%, partially gelled cassava starch, 5.45%.

This added starch produces a fondant, cooked texture. It can also be added directly to formula 3.

Puree of carrots or deep frozen defrosted carrots reduced to puree, or cooked mashed carrot, flakes, powder, dehydrated pieces or rehydrated freeze dried pieces, 76%, water, 20%, formula 3, 5% to 6%.

This recipe was tested with deep frozen courgette roundels, defrosted and reduced to a puree.

Puree of broccoli or deep frozen defrosted broccoli reduced to a puree, or cooked mashed broccoli, flakes, powder, dehydrated pieces or rehydrated freeze dried pieces, 76%, water, 20%, formula 3, 5% to 6%.

Potato puree, 95%, formula 3, 5% to 6%.

Potato puree, 50%, chopped spinach, 45%, formula 3, 5% to 6%.

Potato puree, 50%, deep frozen or fresh, sliced, raw or pre-cooked courgettes, 45%, formula 3, 5% to 6%.

Potato puree, 50%, deep frozen or fresh, sliced, raw or cooked leeks, 45%, formula 3, 5% to 6%.

Potato puree, 50%, deep frozen or fresh, sliced, grated or pureed raw or cooked carrots, 45%, formula 3, 5% to 6%.

Potato puree, 50%, deep frozen or fresh, sliced, raw or cooked broccoli, 45%, formula 3, 5% to 6%.

In the above examples, the potato puree can be fresh cooked or flaked or rehydrated powder.

Chopped cooked beetroot, 75%, water 20%, formula 3, 5%.

Chopped raw or cooked onion, 47.62%, water, 47.62%, formula 6, 4.76%.

Chopped raw or cooked onion, 23.81%, chopped ginger 12.7%, water, 46.83%, fresh chopped cardamom, 2.38%, massale, 4.76%, formula 6, 4.76%.

Chopped raw or cooked onion, 30.66%, water, 42.28%, chopped coriander leaf, 10.57%, chopped parsley, 11.63%, formula 6, 4.86%.

3.3.3. Formula 3 can also be used with cheese to produce a preparation that can be shaped or sliced which melts a little on cooking, retaining a smooth texture. This cheese preparation can be used to produce cheese toppings or to stuff roasts, or it can be incorporated into sausage meat, for example. If its integrity is to be strengthened, in the case in which it is in prolonged contact with salted products, it is possible to replace formula 3 by formula 12 or 15.

Very finely chopped emmenthal, 25%, water, 26%, formula 3, 4%, grated emmenthal, 45%.

Very finely chopped emmenthal, 25%, water, 26%, formula 3, 4%, partially pre-gelled cassava starch, 3%, grated emmenthal, 45%. Coarse chopping or mashing or simple grating in larger proportions is possible.

This second recipe improves smoothness. The added starch produces a very smooth cooked texture. It can be added directly to formula 3 to create a new formula.

To facilitate slicing, it may be useful to cook the molded product or to work with very hot or boiling water.

Shaping can take place before or after gelling as in this case the apparent gelling is not due to the alginate but to absorption of water by the starch and due to “cheese stiffening”. The reaction with the alginate takes place during mixing as the cheese, which is very rich in calcium, accelerates the reaction, and it is this which differentiates this application from the next application.

3.4. Formula 4

This formula, added in a proportion of 5% to 15% to cheese such as emmenthal, part of which is grated, and optionally to water, can produce a cheese preparation which resists cooking, remains in shape and has an in-mouth texture which can be identified as cheese.

Very finely chopped Emmenthal, 28%, water, 14%, formula 4, 10%, partially pre-gelled cassava starch, 3% (it is this added starch which produces a very smooth cooked texture; it can be directly added to formula 3 to create a novel formula), grated Emmenthal, 45%.

The quantity of cassava starch can vary as a function of the desired texture.

If a texture is desired that is softer when cold and almost cold, all or part of the pre-gelled starch can be replaced by native starch.

For hard cheeses, the following procedure is appropriate:

1. Break up (to produce a puree or paste) the first part of the cheese;

2. Add water then powdered ingredients, with mixing;

3. Add the rest of the cheese, grated or in small pieces (this allows the real texture to be retained)

4. Mold or shape

5. Store chilled until gelled; the product can then be sliced.

N.B. To facilitate slicing, it may be useful to cook the molded product or to work with very hot or boiling water.

3.5. Formula 5

This formula 5 comprises an ingredient (citric acid) which can reduce the pH to encourage reaction of the calcium salts with the sodium alginate. It can be used for relatively acidic starting materials for which the calcium salts and retarding agents of formula 3 would not be suitable.

The percentage of the various ingredients varies as a function of the physico-chemical characteristics of the food material.

This formula, added in an amount of 10% to acidified banana puree, optionally supplemented with banana pieces, can produce pieces which are resistant to cooking with a texture close to that of the cooked fruit.

Banana puree from aseptically filled bags, 85%, icing sugar, 5%, formula 4, 10%.

The following method can be employed:

1. Mix all ingredients,

2. Mold

3. Chill until gelled

4. Unmold.

3.6. Formulae 6 and 7

Formulae 6 and 7 comprise vegetable proteins. They are used when more firmness is desired in the finished product, as an alternative to formula 3.

3.7. Formulae 8 and 9

These formulae 8 and 9 comprise a large amount of calcium sulfate and a small amount of tetrasodium pyrophosphate. They will be used when more rapid gelling is to be obtained, by preparing a gel as in method n° 2 of Table III as they are difficult to dredge. However, they will not be compatible with all starting materials, such as some relatively acidic beef pieces. They run the risk of setting too quickly without having time to produce a mixture.

3.8. Formulae 10 and 11

These formulae are similar to formulae 8 and 9, but they also comprise dextrose and can be dredged. However, as for formulae 8 and 9, they are not compatible with all starting materials.

3.9. Formulae 12, 13 and 14

These formulae are close to those of formulae 3, 6 and 7 but they also comprise calcium sulfate. They are used at the same quantity in the case in which the integrity of the product is to be enhanced for safety because of the salt content of the product or if it is marinated after gelling or brought into contact with a salted product such as a stuffing (meat olives, roast, etc) or ham.

Even more advantageously, the quantity of formula is low as regards the piece size and thus the surface to be cohered.

They can also be used when employing preservatives such as potassium lactate, sodium lactate or sodium diacetate, used alone or as a mixture.

“Zygochamys patagonica” scallops, mashed, crumbled, 76.20%, water, 19.04%, formula 12, 4.76%.

Pieces of turkey shoulder meat, 75%, water, 19%, formula 12, 4%.

After gelling, this product, sliced finely, can be made into escalopes for meat olives.

This recipe was tested on pork, beef, mutton, lamb, guinea fowl and duck meat and on various fish, namely salmon, tuna and trout.

Pieces of chicken fillet, 75%, water, 19%, sodium lactate, 1.5%, formula 12, 4%.

Tuna pulp, 14.38%, pieces of tuna loin, 57.32%, water, 17.97%, chopped onion, 5.39%, spices, 1.8%, formula 13, 4.04%.

3.10. Formulae 15, 16 and 17

These formulae are more concentrated in calcium salt than those above. They are more compatible with salty products, but sometimes the finished products have a disagreeable taste.

They are highly useful in the following particular cases:

“Zygochamys patagonica” scallops, mashed, crumbled, 76.20%, water, 19.04%, formula 16, 4.76%

Nile perch fillet, 73%, water, 22%, formula 16, 5%

Washed, shelled cooked crayfish tails, 94.7%, formula 15, 5.3%; this recipe does not work with all crayfish.

Hake pulp, 6% salted, 66%, water, 27%, formula 15, 16 or 17, 7%

(Hake pulp desalted in same volume of water), 70%+water, 30%), 93% to 95%, formula 15, 16 or 17, 5% to 7%.

Concentrated rum distillery liquor, 39%, 9% gel of formula 16, 61%

Tuna pulp 65.18%, water 17.27%, chopped onion, 10.36%, ground black pepper, 0.45%, salt, 1.09%, powdered nutmeg, 0.1%, formula 16, 5.53%.

Pureed foie gras, 87.41%, water, 8.74%, formula 15, 3.85%.

This recipe can be incorporated into specialty meat products such as sausages.

Pureed foie gras, 78.74%, water, 15.75%, salt, 0.63%, pepper powder, 0.016%, formula 15, 4.72% This recipe can be used in a sausage casing. It can also be molded to make timbales of foie gras for oven cooking.

Liquid melted duck fat, 47%, water, 47%, formula 16, 6%.

This recipe produces a product which can be sliced and does not melt on cooking. For greater firmness, the amount of fat can be decreased, the water content can be increased and/or the amount of formula 16 can be increased, or it can be replaced with formula 17. This product can be introduced into salted specialty meat products.

3.11. Formula 18

This formula is close to formula 4, but it comprises more gelled starch and retarding agents. It is more suitable for processing fresh goat's cheese or mozzarella; it also works with emmenthal and certain soft cheeses.

Fresh goat's cheese, 75%, water, 15%, formula 18, 10%.

Chopped mozzarella, 75%, water, 15%, formula 18, 10%.

As with formula 4, the texture can be modified with partially pre-gelled or non pre-gelled cassava starch, or any other texturing agent which can be added to the formula to make another formula.

3.12. Formula 19

This formula comprises only alginate and gelled starch (there is no calcium as it is added subsequently for gelling from the outside, using a calcium solution).

This formula is exclusively reserved for applications aimed at producing separate pieces which never cohere, such as granules or “spaghetti”, slices of meat or fish or marine products the superficial marinade of which is solidified.

The amount and nature of the texturing agent can be changed and may be zero, which would then leave only sodium alginate.

The principle of use consists of preparing a gel which is added to the starting material (optionally mixed until absorption or dredged dry after water absorption), then the products are poured or extruded into a calcium solution or said solution is added by mixing or by coating or by individual immersion in the case of pieces.

This formula and the product produced must be accompanied by immersion in a calcium solution based on calcium chloride, calcium lactate or any other calcium salt which can liberate calcium into the water.

Sliced chicken fillet, 80%, 2% gel of formula 19, 20%, absorption then add 10% of a solution of 1% calcium chloride, 2% calcium lactate and 2% calcium sulfate. The pieces are separated.

Sliced chicken fillet 80% (50% of 4% gel of formula 19+50% commercial liquid marinade), 20%, absorption then addition of 4% of a 10% calcium chloride solution. The pieces are separated and the marinade is solidified. It is also possible to use a recipe other than 19; in this case the composition is selected as a function of the characteristics of the marinade, in particular its pH.

Concentrated rum distillery liquor, 30%, 5% gel with formula 19, 70%, mix intimately then extrude into a 10% calcium chloride solution. Solidified “spaghetti” is obtained, or granules if it is cut as it is produced.

Carrot puree, 98%, formula 19, 2%, mix intimately then extrude into a 10% calcium chloride solution. Solidified “spaghetti” is obtained, or granules if it is cut as it is produced.

All solutions containing calcium lactate must be prepared with water that is sufficiently hot to dissolve it, or they must be heated sufficiently to dissolve it. This is also applicable to the following particular applications.

The food materials can be salted.

3.13. Formula 20

This formula exclusively comprises guar gum as the water retention agent

It resembles formulae 3, 6 and 7, but uses a different supplemental additive, thickening agent or gelling agent which imparts the possibility of adapting and modifying the texture and water retaining power of the finished products.

3.14. Formula 21

This formula is similar to formulae 15, 16 and 17, but with a still higher calcium salt concentration and without a dextrose type dispersing agent and a relatively low gelled starch content.

This type of formula is used when the need for dispersibility of the composition is not vital, as is the case for raw food materials which are mixed, such as purees and pulps, or when a gel can or is to be made.

4. Complementary treatment with a calcium solution In some cases, the use of formulae 1 to 18 and 20, 21 could necessitate or be ameliorated by immersion for a longer or shorter period in a calcium solution, as for formula 19.

4.1. Reinforcing integrity

If, following standing, the products are sufficiently solid to be sliced or unmolded, but not to be cooked, in particular when they are slightly salted or they contain a sodium or potassium lactate or sodium diacetate type preservative, it is preferable and possible to penetrate a calcium solution into the pieces solution by immersion, injection or kneading or to encapsulate or coat or immerse the slices (cut pieces) in a calcium solution.

The immersion time will depend on the nature of the calcium solution, the nature and concentration of the calcium salt, the quantity of calcium to be supplied to the product and the thickness of the portion, and on the desired final result. For a slight improvement in integrity, coating the slices is sufficient.

This application is only useful when using formulae 12, 13, 14, 15, 16 or 17 would not be satisfactory as regards the texture or organoleptic properties.

Turkey leg pieces, 74%, water, 20%, sodium lactate, 2%, mixture 3, 5%; after standing and immersion, the slices are immersed for 10 min in a 5% calcium lactate, 1% calcium chloride solution.

4.2. Definitive separation of pieces

If definite separate pieces of meat, poultry or fish are desired and they are to have a good yield with or without salt (i.e. preserved with added water) on storage and cooking, while allowing chilling and deep freezing with no substantial exudate and a less moist surface appearance when raw, the formulae for restructuring meat and fish are used in the prescribed or lower quantities (the lower the quantity, the lower the water retention effects and, to a certain extent, the lower the separation effect as well).

Sliced chicken filet, 80%, water, 16%, formula 3, 4%; formula to absorption (see table) then addition of 5% of a 3% calcium lactate, 2% calcium sulfate and 1% calcium chloride solution, then draining.

This recipe was tested with slices from different pork, lamb, turkey, ostrich, duck (with and without skin), beef, tuna, farmed trout and salmon muscle.

Well separated pieces are obtained which remain very tender after cooking. This result is further improved if cooking is carried out after standing to allow complete gelling. The calcium solution can also be sprayed onto the products which may or may not be separated, or they can be individually immersed or otherwise into the solution if, for example, two or three pieces enter the calcium solution and are touching. If they touch when the solution is sprayed on, they will remain stuck together, which connects them together then allows them to be shaped and immersed or encapsulated in the calcium solution. The outsides of the pieces will be stuck together and internal gelling will continue for the standing period.

This technique also allows products comprising a plurality of separate layers to be produced, for example for brochettes, by pouring or spraying the calcium solution onto a layer of the product to be restructured.

This technique can be combined with using formula 19 on marine products (one or other of the formulae will be used depending on the chemical characteristics of the marinade), by marinating the product with the marinade described in the above recipe before applying the calcium solution.

When using formula 5 (with calcium hydrogen phosphate), the calcium solution can be replaced by an acidic solution.

4.3. Shaping fairly large pieces constituted by smaller portions

Shaping by extruding smaller pieces has been described in the applications for formula 19.

In this case, the product is prepared as if for restructuring, but a ball or any other shape will be extruded or poured into a calcium solution (see above).

6% salted hake pulp, 74%, water, 20%, formula 16, 6%, mixing and extrusion into a solution of 5% calcium lactate and 5% calcium chloride for 15 min, then removing the granules from the tank and allowing them to stand to allow internal gelling.

When using formula 5 (with calcium hydrogen phosphate), the calcium solution can be replaced by an acidic solution.

What is claimed is:

1. A powdered composition for preparing a heat-stable food product that is at least partially gelled, wherein the composition essentially comprises the following ingredients, as a percentage by weight with respect to a total of 100% of said ingredients:
1) 5% to 50% of sodium alginate, preferably 8% to 25%, more preferably 8% to 15%;
2) 0 to 50% of a slow-dissolving calcium salt that can react with the sodium alginate to form a calcium alginate gel, preferably calcium sulfate or calcium hydrogen phosphate,
3) 0 to 25% of an agent for retarding the reaction between the sodium alginate and said calcium salt, preferably tetrasodium pyrophosphate or sodium citrate, more preferably trisodium citrate;
4) 20% to 95% of a dispersing agent optionally also constituting a water retention agent, selected from sugars, polysaccharides of vegetable origin selected from maltodextrins, native or modified starches and native or modified celluloses, and vegetable proteins.

2. A composition according to claim 1, essentially comprising the following ingredients, as a percentage by weight with respect to a total of 100% of said ingredients representing 100%:
1) 5% to 50% of sodium alginate, preferably 8% to 25%, more preferably 8% to 15%;
2) 0 to 50% of a slow-dissolving calcium salt that can react with the sodium alginate to form a calcium alginate gel, preferably calcium sulfate or calcium hydrogen phosphate,
3) 0 to 25% of an agent for retarding the reaction between the sodium alginate and said calcium salt, preferably tetrasodium pyrophosphate or sodium citrate, more preferably trisodium citrate;
4) 0.1% to 90% of water retaining texturing agent(s) selected from:
starches of vegetable origin, preferably at least pre-gelled; and
vegetable proteins; and
native or modified celluloses; and
vegetable fibers; and
said hydrocolloid polymers such as pectins or gums, of bacterial or vegetable origin; said proportion by weight of texturing agent(s) being constituted by:
0 to 10% of said hydrocolloid polymer(s), with at least 1% of said hydrocolloid polymer(s), or at least 0.1% of said hydrocolloid polymer(s), of bacterial origin, in the presence of less than 15% of the ensemble of said starches, celluloses and vegetable proteins; and
0 to 90% of said starches and vegetable proteins, with at least 15% of said starches, celluloses and vegetable proteins in the presence of less than 1% of said hydrocolloid polymers and less than 0.1% of said hydrocolloid polymers of bacterial origin; and
5) 0 to 85%, preferably 40% to 70%, of dispersing agent(s) selected from sugars and polysaccharides of vegetable origin, more preferably selected from maltodextrins and native starches, and food quality mineral dispersing fillers such as colloidal silica;
the total of said water-retaining texturing agent(s) and said dispersing agents(s) representing 20% to 95%.

3. A composition according to claim 1, comprising 5% to 30% of said calcium salt which can react with sodium alginate.

4. A composition according to claim 1, comprising 0.5% to 15%, preferably 2% to 10% of said agent that retards reaction between the sodium alginate and said calcium salt.

5. A composition according to claim 1, wherein said water retention agent is selected from said pre-gelled starches and said vegetable proteins.

6. A composition according to claim 5, comprising at least 50% of water retention agent which is constituted by a vegetable protein.

7. A composition according to claim 1, wherein said dispersing agent is selected from dextrose, glucose, saccharose and fructose type sugars, preferably dextrose.

8. A composition according to claim 5, wherein said pre-gelled starch has a grain size of 0.020 mm to 1 mm, preferably 0.025 mm to 0.4 mm.

9. A composition according to claim 1, comprising cassava starch, which is optionally partially pre-gelled, as said water-retention agent.

10. A composition according to claim 2, comprising:
8% to 25% of sodium alginate;
15% to 50% of water-retaining texturing agent selected from said pre-gelled starch and said vegetable protein, preferably pre-gelled cassava starch; and
30% to 70% of said dispersing agent, preferably of the sugar or maltodextrin type, more preferably of the dextrose type.

11. A composition according to claim 1, comprising:
0 to 10% of said dispersing agent, preferably 0%; and
at least 20%, preferably at least 40% of said water-retaining agent selected from said pre-gelled starches and said vegetable proteins, preferably said pre-gelled starches.

12. A composition according to claim 11, comprising:
8% to 25% of said sodium alginate;
0% of said calcium salt that can react with the alginate;
0.5% to 10% of said retarding agent;
0 to 10% of said dispersing agent, preferably 0%;
60% to 90% of said water retention agent selected from said pre-gelled starches, preferably a pre-gelled cassava starch, more preferably with a grain size of 0.020 mm to 1 mm; and
0 to 20% of an emulsifying salt such as a polyphosphate.

13. A composition according to claim 1, wherein said calcium salt is calcium sulfate and said retarding agent is tetrasodium pyrophosphate.

14. A composition according to claim 1, wherein said calcium salt is calcium phosphate, preferably calcium hydrogen phosphate, and said retarding agent is sodium citrate, preferably trisodium citrate.

15. A composition according to claim 1, comprising additional ingredients which can reduce the pH, preferably citric acid, more preferably in an amount which is less than 1.5%.

16. A composition according to claim 1, the composition being supplemented by a fat or oil of human or animal food quality.

17. A method of preparing a food product that is at least partially gelled, wherein the method comprises bringing a composition in accordance with claim 1 into contact with a raw food material, preferably by mixing.

18. A method according to claim 17, comprising mixing a composition according to claim 1 with said raw food material and water.

19. A method according to claim 17, wherein all of the ingredients of said composition, it being dispersed in the powdered state, are mixed simultaneously with said starting material and any water to be added until the distribution of said composition about said starting material is homogeneous and, if appropriate, until the water has been absorbed by said starting material, prior to the onset of gelling, then it is allowed to stand to allow gelling.

20. A method according to claim 17, wherein a mixture is produced comprising the following percentages by weight of the components to give a total of 100%:
1% to 15% by weight of said composition; and
the remainder, i.e. 85% to 99% by weight, is constituted by all of said raw food material, supplemented with water if appropriate.

21. A method according to claim 20, wherein a mixture comprising 2% to 10% by weight of said composition is produced.

22. A method according to claim 20, wherein said raw food material is constituted by moist or rehydrated food material and the mixture comprises 0 to 50%, preferably 0 to 30% by weight of added water.

23. A method according to claim 20, wherein said raw food material is constituted by a fat, or by dehydrated or semi-moist food material containing bound water, and the mixture comprises 10% to 95% by weight of added water.

24. A method according to claim 17, wherein a solution of fast-dissolving calcium salt is employed, such as calcium chloride or calcium lactate, preferably a 0.5% to 10% solution, which is introduced into the mixture of the various components, preferably by injection or kneading at the end of mixing, or in which it is immersed, or with which the product resulting from mixing said components is coated before, during or after gelling.

25. A method according to claim 17, wherein a food product is obtained in which the pieces of said raw food material cohere.

26. A method according to claim 24, wherein the product resulting from mixing said components is immersed or coated in or with said fast-dissolving calcium solution or said fast-dissolving calcium solution is introduced into said product resulting from mixing said components, during or after gelling.

27. A method according to claim 24, wherein a food product is obtained in which the pieces of raw food material remain separate.

28. A method according to claim 27, wherein said fast-dissolving calcium solution is introduced into the mixture of the various components when mixing is complete, or the products resulting from mixing said compositions are immersed or coated in or with said fast-dissolving calcium solution, before or during gelling.

29. A method according to claim 17, wherein said raw food material is weakly acidic (pH>3.5), neutral or alkaline, the calcium salt is calcium sulfate and the retarding agent is sodium pyrophosphate.

30. A method according to claim 17, wherein said starting material is an acidic starting material with a pH of <3.5, the calcium salt is calcium phosphate, preferably calcium hydrogen phosphate, and the retarding agent is sodium citrate, preferably trisodium citrate.

31. A method according to claim 17, wherein said starting material is cheese and said composition is a composition according to claim 11.

32. A method according to claim 17, wherein said starting material is a moist starting material selected from meat, fish, fruit, vegetables and fats, and said composition is a composition according to claim 10.

33. A heat-stable food product which is at least partially gelled, obtained by the method according to claim 17.

34. A food product according to claim 33, having water-retention properties on storage, if appropriate on defrosting and on cooking, which are improved with respect to those of the raw food material contained therein before mixing.

35. A food product according to claim 33, the product being constituted by pieces of said raw food material which cohere.

36. A food product according to claim 33, the product being constituted by separate pieces of said raw food material.

37. A food product according to claim 35, the product being a ball, a piece for a brochette or fillet, slice, tournedos, slab, dice, large block, granule, or fine slice of meat, poultry or fish.

38. A food product according to claim 33, the product being constituted by tarts in the form of a vegetable or fruit puree, preferably pre-cooked.

39. A food product according to claim 33, the product being constituted by pieces of cheese or cheese preparation, preferably based on emmenthal, goat's cheese or mozzarella.

40. A product according to claim 33, the product being constituted by heat-stable solidified fat.

41. A food product according to claim 36, the product being coated with said calcium solution according to the method of claim 28, preferably in the form of a marinade, which endows it with a solid appearance.

42. A food product according to claim 41, the product being obtained from said starting material mixed with said composition, preferably incorporated in the form of a gel into a marinade, the product resulting from said mixture being coated with said calcium solution according to the method of claim 28, which endows it with a solid appearance.
